(19) United States
(12) Patent Application Publication
(10) Pub. No.: US 2004/0041966 A1
(43) Pub. Date: Mar. 4, 2004

(54) Liquid crystal display device having hemi-ellipsoid bumps on reflection electrode

(76) Inventors: Fu-Jen Ko, Hsinchu (TW); Kuo-Yu Huang, Hsinchu (TW)

Correspondence Address: RABIN & Berdo, PC, 1101 14TH STREET, NW, SUITE 500, WASHINGTON, DC, 20005, US

(21) Appl. No.: 10/630,941

(22) Filed: Jul. 31, 2003

(30) Foreign Application Priority Data
Aug. 30, 2002 (TW) 91119776

(51) Int. Cl. G02F 1/1335

(52) U.S. Cl. 349/113

(57) ABSTRACT

A reflection type liquid crystal display device. A first insulation substrate is transparent and has a transparent electrode on an inner surface thereof. A second insulation substrate has a reflection electrode on an inner surface thereof, wherein a surface of the reflection electrode has hemi-ellipsoid bumps. A liquid crystal layer is inserted between the transparent electrode and the reflection electrode. A device for generating an electrical field between the transparent electrode and the reflection electrode is provided. Thus, the liquid crystal display device of the present invention can provide a relatively bright image in a definite direction.

### BACKGROUND OF THE INVENTION

1. Field of the Invention

The present invention relates to a reflection type liquid crystal display (RLCD) device, and more particularly, to a liquid crystal display device whose reflection electrode has hemi-ellipsoid bumps.

2. Description of the Related Art

High definition and multicolor display characteristics low power consumption and lower voltage make LCDs a leading display device.

There are two types of LCDs: a transmission type display device using a backlight source; and a reflection type display device using ambient light. Reflection type display devices are light and thin, and consumes less power because a backlight module is unnecessary. Reflection type displays maintain excellent display quality outdoors, thus they are widely used in portable devices.

Conventionally, in order to enhance reflectivity, a reflection electrode 110 of the reflection type display device has hemispherical bumps 120, as shown as FIG. 1B. FIG. 1A is a reflectivity radar sketch showing the distribution of the light reflected from the hemispherical bumps 120. Referring to FIG. 1A, the light reflected from the hemispherical bumps 120 is approximately evenly distributed in all directions.

When using a portable device, a user's eyes will usually locate a definite viewing angle. However, the conventional reflection electrode with hemispherical bumps cannot control the direction of the reflective light. That is, the reflection type display device with the hemispherical bumps has poor directional properties, and cannot provide a relatively bright image in a definite direction.

### SUMMARY OF THE INVENTION

The object of the present invention is to provide a reflection type liquid crystal display device which can provide a relatively bright image in a definite direction.

Another object of the present invention is to provide a reflection type liquid crystal display device whose reflection electrode has hemi-ellipsoid bumps.

In order to achieve these objects, a reflection type liquid crystal display device is provided. A first insulation substrate is transparent and has a transparent electrode on an inner surface thereof. A second insulation substrate has a reflection electrode on an inner surface thereof, wherein a surface of the reflection electrode has symmetric hemi-ellipsoid bumps or inclined hemi-ellipsoid bumps. The cross sections of the symmetric hemi-ellipsoid bumps and the inclined hemi-ellipsoid bumps are ellipses. A liquid crystal layer is inserted between the transparent electrode and the reflection electrode. A device for generating an electrical field between the transparent electrode and the reflection electrode is provided.

The present invention improves on the prior art in that the reflection electrode has symmetric hemi-ellipsoid bumps or inclined hemi-ellipsoid bumps, capable of projecting most of the reflective light in a definite direction. Thus, the reflection type liquid crystal display device of the invention can provide a relatively bright image in a definite direction and ameliorate the disadvantages of the prior art.

### BRIEF DESCRIPTION OF THE DRAWINGS

The present invention can be more fully understood by reading the subsequent detailed description in conjunction with the examples and references made to the accompanying drawings, wherein:

FIG. 1A is a reflectivity radar sketch showing the distribution of the reflective light reflected from the conventional hemispherical bumps;

FIG. 1B is a sectional view showing the conventional reflection electrode with hemispherical bumps;

FIG. 2A is a sectional view, according to the present invention, showing the reflection electrode with symmetric hemi-ellipsoid bumps;

FIG. 2B is a plane view showing the symmetric hemi-ellipsoid bump of FIG. 2A;

FIG. 3A is a top view, according to the present invention, showing the reflection electrode with inclined hemi-ellipsoid bumps; wherein the contour lines are shown to illustrate the cross (or horizontal) sections of the hemi-ellipsoid bumps are ellipses;

FIG. 3B is a sectional view of the inclined hemi-ellipsoid bump taken along line C-C′ in FIG. 3A;

FIG. 4 is a reflectivity radar sketch showing the distribution of the reflective light reflected from the present hemi-ellipsoid bumps projected in a definite direction; and

FIG. 5 is a sectional view showing the application of the present invention to a liquid crystal display device having hemi-ellipsoid bumps on the reflection electrode.

### DETAILED DESCRIPTION OF THE INVENTION

With reference to the drawings, preferred embodiments of the invention are described below.

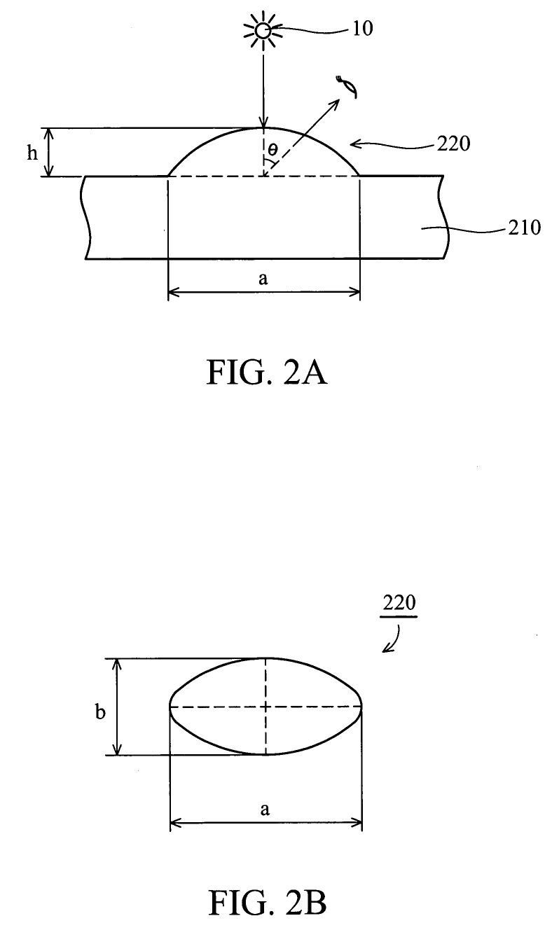

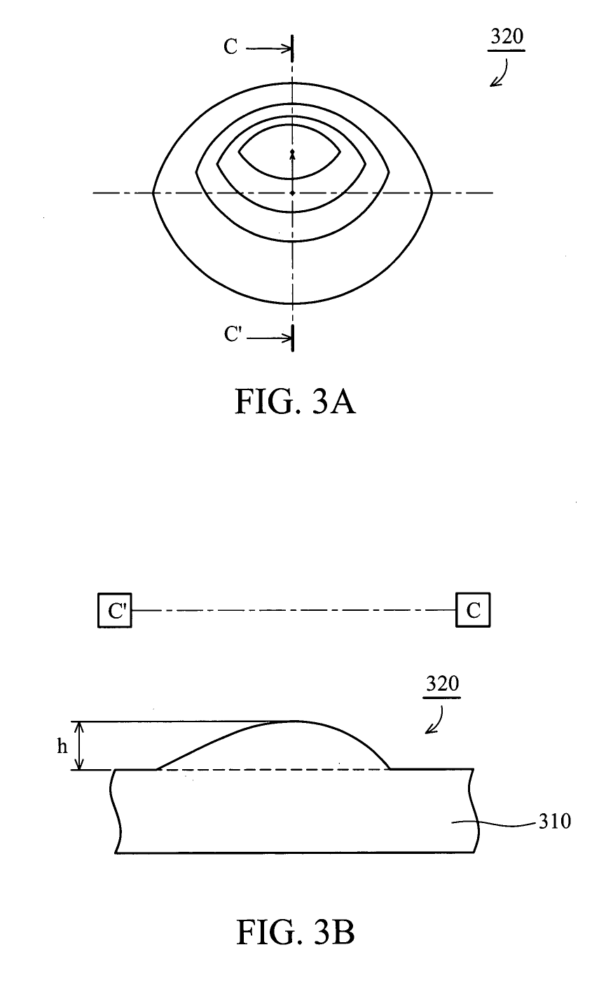

FIG. 2A is a sectional view showing the reflection electrode with symmetric hemi-ellipsoid bumps. FIG. 2B is a plane view showing the symmetric hemi-ellipsoid bump of FIG. 2A. FIG. 3A is a top view showing the reflection electrode with inclined hemi-ellipsoid bumps. FIG. 3B is a sectional view of the inclined hemi-ellipsoid bump taken along line C-C′ in FIG. 3A. Numerals 210 and 310 indicate reflection electrodes. Numeral 220 indicates asymmetric hemi-ellipsoid bump. Numeral 320 indicates an inclined hemi-ellipsoid bump.

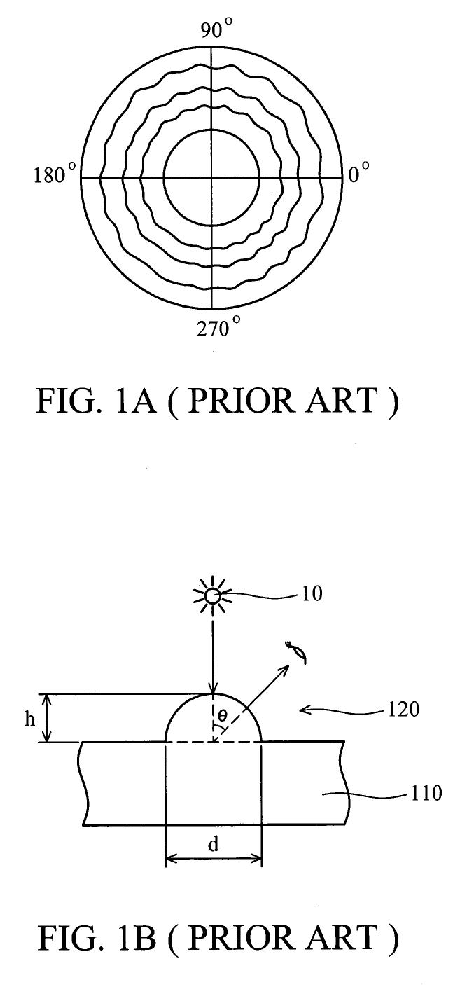

FIG. 1B is a sectional view showing the conventional reflection electrode 110 with hemispherical bumps 120. The diameter of the hemispherical bump 120 is “d” and the height of the hemispherical bump 120 is “h”. In FIGS. 2A and 2B, the long axis of the symmetric hemi-ellipsoid bump 220 is “a”, the short axis of the symmetric hemi-ellipsoid bump 220 is “b” and the height of the symmetric hemi-ellipsoid bump 220 is “h”.

In FIGS. 1B and 2A, an incident ray provided from a light source 10 is introduced into the reflection electrode 110 with the hemispherical bump 120 and the reflection electrode 210 with the symmetric hemi-ellipsoid bump 220, wherein the light source 10 is located above the hemispherical bumps 120 and the symmetric hemi-ellipsoid bumps 220. A reflectivity detector (symbolized by an eye) is located at a viewing angle θ (30°) along the long axis direction to measure the reflectivity of the reflection electrodes 110 and 210. The following table 1 shows the experimental result.

TABLE 1

| | the reflection | the reflection |
|---|---|---|
| | electrodes 110 with | electrodes 210 with |
| | the hemispherical | the symmetric |
| | bump 120 (the prior | hemi-ellipsoid bump |
| | art) | 220 (the invention) |
| Viewing angle | 30° | 30° |
| θ | | |
| height “h” | 1 μm | 1 μm |
| other size(s) | Diameter | long axis |
| | “d = 10 μm” | “a = 18 μm” |
| | | short axis |
| | | “b = 10 μm” |
| reflectivity | about 30% | about 50% |

According to table 1, it is identified that the reflectivity of the reflection electrode 210 with the symmetric hemi-ellipsoid bump 220 is greater than the reflection electrode 110 with the hemispherical bump 120 in the long axis direction. That is, the symmetric hemi-ellipsoid bump 220 can distribute most of the reflective light in a definite direction.

FIGS. 3A and 3B illustrate another type of hemi-ellipsoid bump which is an inclined hemi-ellipsoid bump 320 according to the present invention. Also, the contour lines of the FIG. 3A illustrate the cross (or horizontal) sections of the hemi-ellipsoid bump are ellipses. As a demonstrative example, the inclined hemi-ellipsoid bump 320 is tilted forward in FIGS. 3A and 3B (in this example, the C end is defined as a front end and the C′ end is defined as a rear end). The inclined hemi-ellipsoid bump 320 can further increase reflective intensity in a definite direction as the rear surface area of the bump 320 is greater than the front surface area of the bump 320, causing most of the reflective light to scatter backward. Thus, the reflection electrode 310 with the inclined hemi-ellipsoid bumps 320 has good directional properties, which can control the distribution of most of the reflective light in a definite direction.

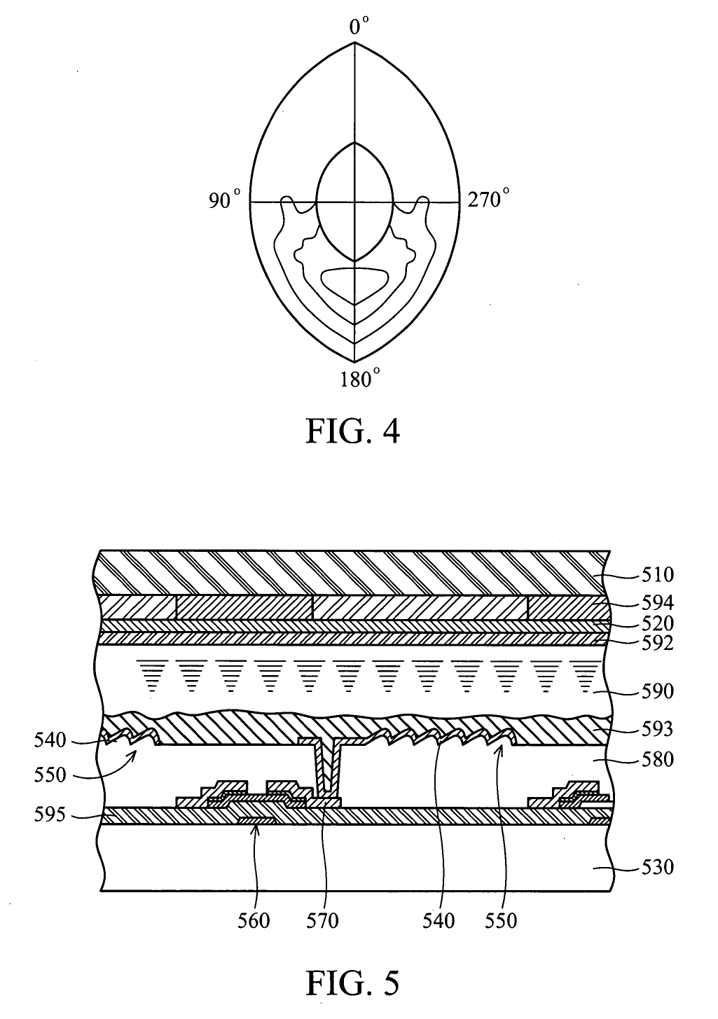

FIG. 4 is a reflectivity radar sketch according to the reflection electrode 310 with the inclined hemi-ellipsoid bumps 320. The light source (not shown) is located above the inclined hemi-ellipsoid bumps 320. The rings in FIG. 4 indicate differential reflective intensity. According to FIG. 4, it is found that the reflectivity of the reflection electrodes 310 with the inclined hemi-ellipsoid bumps 320 is concentrated in a definite direction. In this example, the reflectivity of the reflection electrodes 310 with the inclined hemi-ellipsoid bumps 320 is concentrated at the 180° direction (the rear direction).

It should be noted that the cross (or horizontal) sections of the inclined hemi-ellipsoid bump 320 are ellipses having a long axis and a short axis respectively. Nevertheless, following an increase in the height of the inclined hemi-ellipsoid bump 320, the intersect point of the long axis and short axis moves toward one direction. That is, the intersect points at any contour line of the inclined hemi-ellipsoid bump 320 are not overlapping. The shift in one direction according to the inclined hemi-ellipsoid bump 320 is shown in FIG. 3A.

Generally, considering the gap distance of the liquid crystal layer and the pixel size, the size of the above-mentioned bump 220/320 is preferably controlled as follows. For example, the long axis is 5˜20 μm, the short axis is shorter than the long axis (that is, the short axis is shorter than 5˜20 μm, for example, the short axis is 2.5˜10 μm) and the height is 0.5˜2 μm. It is preferred that the short axis is half the length of the long axis. Also, the optimal shift in one direction according to the inclined hemi-ellipsoid bump 320 depends on the viewing angle direction of the user. For instance, the rear surface area of the bump 320 faces the viewing angle direction, so as to allow most of the reflected light to scatter to the eyes of the user.

The application of the present invention to a liquid crystal display device having hemi-ellipsoid bumps on reflection electrode is provided, as shown as FIG. 5.

In FIG. 5, a first insulation substrate 510 (upper substrate) that is transparent and has a transparent electrode 520 on an inner surface thereof is provided. The first insulation substrate 510 can be a glass substrate. The transparent electrode 520 can be an indium tin oxide (ITO) layer. A color filter 594 can be disposed between the first insulation substrate 510 and the transparent electrode 520. Moreover, an alignment film 592 is formed on the inner surface of the transparent electrode 520.

In FIG. 5, a second insulation substrate 530 (lower substrate) having a reflection electrode 540 on an inner surface thereof is provided. The surface of the reflection electrode 540 has hemi-ellipsoid bumps 550, wherein the hemi-ellipsoid bump 550 can be a symmetric hemi-ellipsoid bump or an inclined hemi-ellipsoid bump. The second insulation substrate 530 can be a glass substrate. The reflection electrode 540 may be an aluminum (Al) layer or a silver (Ag) layer. Moreover, an alignment film 593 is formed on the reflection electrode 540. It should be noted that the cross section of the hemi-ellipsoid bump 550 is an ellipse.

In FIG. 5, a pixel driving device 560, such as a thin film transistor (TFT), is formed on the second insulation substrate 530. The pixel driving device 560 is used to generate an electrical field between the transparent electrode 520 and the reflection electrode 540. A drain electrode 570 of the TFT 560 electrically connects the reflection electrode 540. Numeral 595 indicates a gate insulation layer. In addition, a photosensitive organic insulation layer 580 is formed between the TFT 560 and the reflection electrode 540.

In FIG. 5, a liquid crystal layer 590 is inserted between the transparent electrode 520 and the reflection electrode 540.

Thus, the reflection electrode of the present invention has symmetric hemi-ellipsoid bumps or inclined hemi-ellipsoid bumps, which project most of the reflective light in a definite direction. The reflection type liquid crystal display device according to the invention significantly provides a relatively bright image in a definite direction and ameliorates the disadvantages of the prior art.

Finally, while the invention has been described by way of example and in terms of the above, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A reflection type liquid crystal display device, comprising:
a first insulation substrate that is transparent and has a transparent electrode on an inner surface thereof;
a second insulation substrate having a reflection electrode on an inner surface thereof, wherein a surface of the reflection electrode has hemi-ellipsoid bumps;
a liquid crystal layer inserted between the transparent electrode and the reflection electrode; and
a device for generating an electrical field between the transparent electrode and the reflection electrode.

2. The reflection type liquid crystal display device according to claim 1, wherein the first insulation substrate is a glass substrate.

3. The reflection type liquid crystal display device according to claim 1, wherein the transparent electrode is an ITO (indium tin oxide) layer.

4. The reflection type liquid crystal display device according to claim 1, wherein the reflection electrode is an aluminum (Al) layer.

5. The reflection type liquid crystal display device according to claim 1, wherein the hemi-ellipsoid bump has a long axis, a short axis and a height.

6. The reflection type liquid crystal display device according to claim 1, wherein the long axis is 5˜20 μm.

7. The reflection type liquid crystal display device according to claim 6, wherein the short axis is shorter than the long axis.

8. The reflection type liquid crystal display device according to claim 5, wherein the height is 0.5˜2 μm.

9. The reflection type liquid crystal display device according to claim 1, wherein a cross (or horizontal) section of the hemi-ellipsoid bump is an ellipse.

10. The reflection type liquid crystal display device according to claim 1, wherein the hemi-ellipsoid bump is an inclined hemi-ellipsoid bump, and a cross (or horizontal) section of the inclined hemi-ellipsoid bump is an ellipse.

11. The reflection type liquid crystal display device according to claim 1, wherein the device for generating an electrical field is a thin film transistor.

12. The reflection type liquid crystal display device according to claim 11, wherein the thin film transistor is formed on the second insulation substrate and a drain electrode of the thin film transistor electrically connects the reflection electrode.

13. The reflection type liquid crystal display device according to claim 11, further comprising:
an organic insulation layer formed between the thin film transistor and the reflection electrode.

14. A reflection type liquid crystal display device, comprising:
a first insulation substrate that is transparent and has a transparent electrode on an inner surface thereof;
a second insulation substrate having a reflection electrode on an inner surface thereof, wherein a surface of the reflection electrode has hemi-ellipsoid bumps;
a liquid crystal layer inserted between the transparent electrode and the reflection electrode; and
a device for generating an electrical field between the transparent electrode and the reflection electrode;
wherein the hemi-ellipsoid bump has a long axis, a short axis, and a height;
wherein the long axis is 5˜20 μm, the short axis is shorter than the long axis, and the height is 0.5˜2 μm.

15. The reflection type liquid crystal display device according to claim 14, wherein the first insulation substrate is a glass substrate.

16. The reflection type liquid crystal display device according to claim 14, wherein the transparent electrode is an ITO (indium tin oxide) layer.

17. The reflection type liquid crystal display device according to claim 14, wherein the reflection electrode is an aluminum (Al) layer.

18. The reflection type liquid crystal display device according to claim 14, wherein a cross (or horizontal) section of the hemi-ellipsoid bump is an ellipse.

19. The reflection type liquid crystal display device according to claim 14, wherein the hemi-ellipsoid bump is an inclined hemi-ellipsoid bump, and a cross (or horizontal) section of the inclined hemi-ellipsoid bump is an ellipse.

20. The reflection type liquid crystal display device according to claim 1, wherein the device for generating an electrical field comprises a thin film transistor.
